(19) United States
(12) Patent Application Publication
(10) Pub. No.: US 2007/0048111 A1
(43) Pub. Date: Mar. 1, 2007

(54) External, removable frame structure for ATV

(76) Inventor: Patrick Truchon, Chicoutimi (CA)

Correspondence Address: INVENTARIUM, Suite 1607, 4050 Rosemont Blvd, Montreal, QC, H1X 1M4, CA

(21) Appl. No.: 11/212,202

(22) Filed: Aug. 25, 2005

(51) Int. Cl. B60P 9/00

(52) U.S. Cl. 414/462

(57) ABSTRACT

An external, removable frame structure for ATV is made out of tubing making out three sides hingedly attached to each other and having a hitch ball attachment and clip on attachment to a cross beam which is permanently attached to the frame of the ATV. The frame structure has a pair of extending arms to which accessories or objects can be attached.

### BACKGROUND OF THE INVENTION

1. Field of the Invention

The invention relates generally to frame structures but more particularly to a frame structure used for supporting objects and equipment on an ATV.

2. Background of the Invention

Four wheel ATVs are used for a variety of purposes ranging from mere leisure activities to uses as a workhorse in forestry and other demanding work situations. According to the requirements, various accessories and modifications to the basic ATV have been made over the years. Some of the modifications include creating a framelike structure capable of accepting accessories such as a hoist or a crane while other frame structures are used for carrying or transporting heavy or large objects. Some of those frame structures use an existing ball hitch on the ATV as a means for hooking the frame structure in a semi permanent fashion, others use the existing footrests of the ATV as an additional support point for the frame structure. Because of the great variety of tasks an ATV is required to do, there is plenty of room for a variety of types of frame structures.

### SUMMARY OF THE INVENTION

In view of the needs for various types of frame structures, the present invention, which will be described subsequently in greater detail, is to provide objects and advantages which are:

To provide an easily mountable and dismountable frame structure.

To provide a frame structure that uses already available attachment and support means on the ATV.

To provide a frame structure that has collapsible extensions that compact the size of the frame structure when not in operating mode.

To attain these ends, the present invention generally comprises a frame structure made out of tubing making out three sides hingedly attached to each other and having a hitch ball attachment and clip on attachment to a cross beam which is permanently attached to the frame of the ATV. The frame structure has a pair of extending arms to which accessories or objects can be attached.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

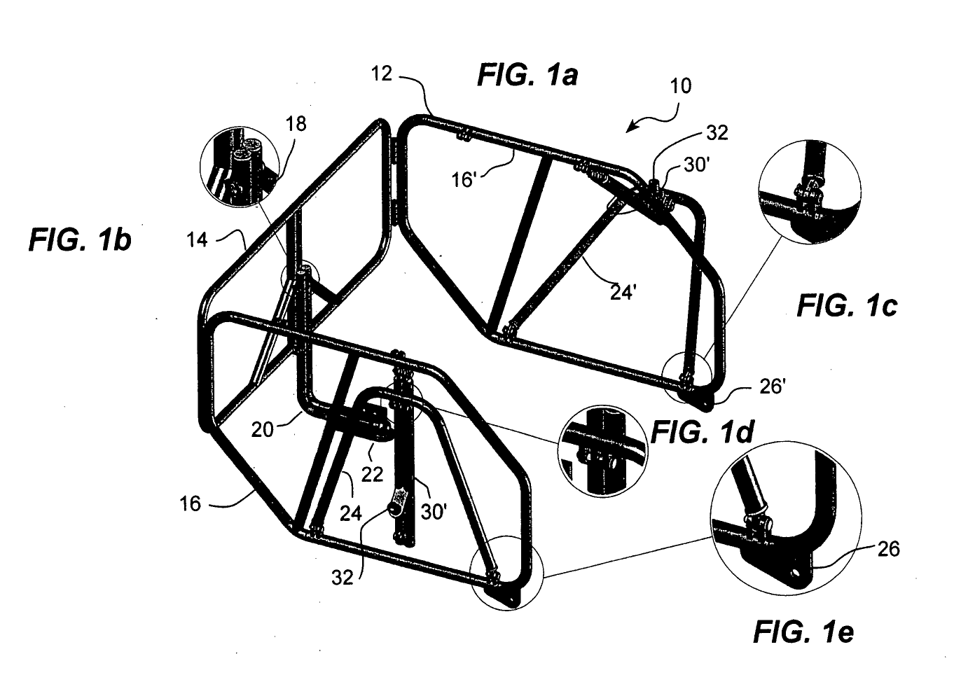

FIGS. 1a-e Perspective view of the frame structure accompanied with close-up views of sections.

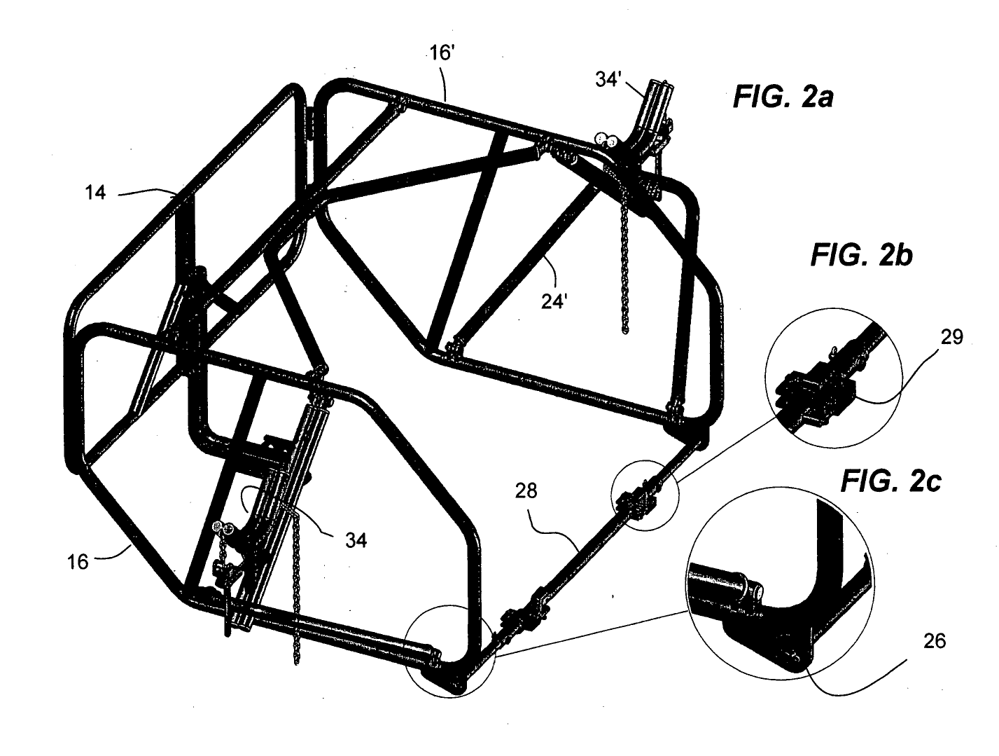

FIGS. 2a-c Perspective view of the frame structure with arms protracted and ATV frame attachment beam and with close-up views of sections.

### DETAILED DESCRIPTION OF THE PREFERRED EMBODIMENT

An external, removable frame structure for ATV (10) has three sides; a rear (14) and two lateral sides (16, 16′). Each rear and sides (14, 16, 16′) being generally made out of bent tubings (12) which, according to the type of manufacturing process selected, can be constituted of several permanently connected pieces forming the rear and sides (14, 16, 16′) or a single bent piece with both ends connected together. The two lateral sides (16, 16′) are hingedly attached to the rear (14). The rear (14) has an attachment bracket (18) onto which attaches, in a semi permanent fashion, an elbow (20) which has a hitch ball attachment (22) for hitching onto a ball hitch of an ATV (not shown). Of course, there could be other types of attachment possible which are known in the art and could fall within the scope of the invention.

Each side (16, 16′) has an extension arm assembly (24, 24′) and clip-on attachment brackets (26, 26′) which clip onto a cross beam (28) for quick and easy dissconnect from the cross beam (28) which is itself attached underneath the frame of the ATV (not shown) in a more permanent fashion by way of ATV frame attachment brackets (29). Instead of being attached to the cross beam (28), the sides (16, 16′) could rest on the footrests (not shown) of the ATV as is known in the art. Each extension arm assembly (24, 24′) is pivotally attached to the side (16′ 16′) and will pivot outwardly until stopped by a rod (30, 30′) which temporarily attaches to the extension arm assembly (24, 24′) on one extremity and is permanently pivotally attached to the side (16, 16′). Each rod is configured so as to receive a variety of accessories on its stem (32, 32′). For example, FIG. 2a shows a cradle and chain assembly (34, 34′) for carrying logs (not shown). In this particular case, where logs or tree trunks are to be carried, a hoist (not shown) attached, in whole or in part, to the frame structure (10) can lift the logs and place them into the cradle and chain assembly (34, 34′). The frame structure (10) is capable of accepting clamping or attachment means designed to hold such accessories as a hoist (not shown) and other types of accessories that cooperate with other components connected to the stem (32, 32′) It should be understood that the stems (32, 32′) and the extension arm assembly (24, 24′) can also support a variety of accessories.

By extending outwardly, the extension arm assembly (24, 24′) provides unencoumbered carrying of large objects while maintaining a low center of gravity and excellent balance to the ATV.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An external, removable frame structure for ATV comprising:
a rear and two lateral sides;
said two lateral sides being hingedly attached to said rear;
means for attaching said removable frame structure to an ATV;
each said side having an extension arm assembly;
said extension arm assembly being pivotally attached to said sides and pivoting outwardly until stopped by a rod which temporarily attaches to said extension arm assembly on one extremity and permanently pivotally attached to said side;
said rod configured so as to receive a variety of accessories on its stem.

2. An external, removable frame structure for ATV as in claim 1 wherein:
said means for attaching said removable frame structure to an ATV being in the form of an attachment bracket on said rear onto which attaches, in a semi permanent fashion, an elbow and said elbow having a hitch ball attachment for hitching onto a ball hitch of an ATV.

3. An external, removable frame structure for ATV as in claim 1 wherein:
clip-on attachment brackets on said sides clipping onto a cross beam which is permanently attached underneath a frame of said ATV.

4. An external, removable frame structure for ATV as in claim 1 wherein:
Each said rear and said sides being generally made out of bent tubings which, can be constituted of several permanently connected pieces forming a rear and sides, or a single bent piece with both ends connected together.
